(19) United States
(12) Patent Application Publication
(10) Pub. No.: US 2015/0367591 A1
(43) Pub. Date: Dec. 24, 2015

(54) Drive System For Deforming A Web-Like Material

(71) Applicant: BAUMÜLLER ANLAGEN-SYSTEMTECHNIK GMBH & CO. KG, Nurnberg (DE)

(72) Inventors: Gunter Hessenauer, Pohlheim (DE); Olaf Richter, Stein (DE)

(21) Appl. No.: 14/439,687

(22) PCT Filed: Nov. 26, 2012
(86) PCT No.: PCT/EP2012/073612

§ 371 Date: Sep. 9, 2015

(51) Int. Cl. B31F 1/28

(52) U.S. Cl. CPC B31F 1/2831; B31F 1/2863

(57) ABSTRACT

A drive method for moving a first and a second forming means for processing a web-like material (material web) arranged between the same, in particular for deforming for example a paperboard web in a corrugated manner, wherein the forming means, and possibly the material web therebetween, are brought into force-fitting and/or form-fitting engagement, and the forming means are each assigned a dedicated drive, and the drives are activated such that the forming means apply a predetermined pressing force against one another and possibly to the material web.

### BACKGROUND OF THE INVENTION

The invention relates to a drive method for moving a first and a second forming means for processing a web-like material (referred to as a “material web”) arranged between the same. The invention relates in particular to corrugated-type forming of a web of paperboard or cardboard, for example, for which purpose the forming means and optionally the material web are brought into a force-fitting and/or form-fitting engagement in between.

Furthermore, the invention relates to a drive arrangement which is suitable in particular for performing the aforementioned method and has two forming means that can be brought together into a force-fitting and/or a form-fitting engagement and are arranged in such a way that a material web to be processed can find room between them.

DE 195 35 602 A1 discloses a method and a device for producing honeycomb material from webs of an embossable material, such as cardboard, plastic or a lightweight metal. A material web is guided through a roller pair with profiling like a gear wheel to create a half honeycomb web. Furthermore, the web is pretreated by means of a pair of embossing rotors.

DE 10 2005 052 691 B3 describes a method and a device for producing a honeycomb structure, wherein corresponding strips of material are profiled by means of profiling rollers. To do so, the strips of material are passed between two opposing profile rollers, which have protrusions along their circumference, intermeshing with one another in a form-fitting manner. The material web is embossed with a periodic profile, for example, a regular trapezoidal profile, corresponding to these gear wheel-type protrusions.

### SUMMARY OF THE INVENTION

The invention is based on the object of creating a drive structure for the forming means, so that the efficiency of a material web-forming operation can be increased. To solve this problem, the drive method defined in claim 1 and the drive arrangement, as defined in the other independent claim, are proposed. Expedient optional embodiments are derived from the dependent claims.

Since the forming means are each actively driven with their own dedicated drive means, these can be controlled and coordinated with one another, so that, in the wake of profiling and/or shaping the material web, the pressing of the material web between the forming means can also be accomplished at the same time in a manner that is both time-saving and component-saving and can always be adapted to the respective boundary conditions and requirements in a flexible manner. With the assignment of an independently activatable drive means to each of the forming means, their shaping torques can be varied in a targeted manner in the sense of a constant surface pressure, in particular in forming a honeycomb shape, if the drive means mesh with one another in a force-fitting and/or form-fitting manner. In particular the slave drive operates with a selected force or torque, such that the two forming means exert a predefinable pressing force on the material web passing between them. In particular the force and/or torque exerted by the slave drive on the forming means is/are selected, so that the pressing force creates a constant surface pressure on the material.

In many cases the web material can be processed with a certain water resistance. This is obtained due to the fact that the web material is impregnated with resin but is not saturated. With adequate pressure on the web material by means of the invention, the quality of special water resistance is not yet required in the finished product. Thus, for example, in the case of a honeycomb made of paper/paperboard, a moisture resistance can be created, such as that which could previously be achieved only with high-quality materials such as plastic, metal or CFRP (carbon fiber-reinforced plastics). The torque exerted by the slave drive on the forming means is selected so that the pressing force creates a constant surface pressure on the material.

With this invention, the material web can be shaped as well as pressed into a corrugated shape or any other shape between intermeshing forming means in one working step, so that its water uptake capacity is reduced. To do so, according to one embodiment of the invention, it is expedient for the drives of the forming means to be activated in such a way that the latter are braced against one another, optionally with the material web in between, to create the pressing force (cf. claim 2). In other words, the drives are activated in such a way that they press the forming means that are in force-fitting and/or form-fitting connection against one another. The forming means are driven in such a way that one drives the other or one brakes the other.

To effectively coordinate the forces or torques applied to the forming means by the drives, in particular to achieve a constant surface pressure on the material web, according to one optional embodiment of the invention, it is proposed that, of the drives, a first one is used as the master drive connected to the first forming means and a second one is used as the slave drive connected to the second forming means. In doing so, the slave drive is activated or operated as a function of or under the influence of a position value of the master drive and/or of the first forming means (hereinafter referred to as the “master position value”) (cf. claim 3). Thus, a respective torque setpoint value is preselected for the slave drive in relation to the position of the master drive and/or of the forming means activated by it. The slave drive thus generates its force or torque as a function of the (rotational) position (master position value) of the master drive and/or of the (first) forming means connected to it. In that the activation of the slave drive is linked to the master position value through this master/slave configuration, a correlation and/or a relationship of the forces or torques exerted by the slave drive can be implemented with the respective position of the master drive or of the (first) forming means thereby driven. It is thus possible to take into account specific locally varying shaping profiles between the forming means in implementation of a constant surface pressure.

In refinement of this embodiment of the invention, a force or torque setpoint value is assigned to the master position values, as a function of which or influenced by which the slave drive is triggered or operated (cf. claim 4). Therefore, if the master drive is in a rotationally fixed or motion-fixed connection to the first forming means assigned thereto, for example, in the manner of a direct drive, the position-variable deformation profile can be mapped on the forming means for the corresponding generation of a torque setpoint value for the slave drive and utilized. In this sense, a special embodiment of the invention consists of making the allocation between the master position values and the force or torque setpoint values according to a deformation profile, an external contour or some other geometry or topography of the forming means and/or in accordance with the pressing force to be generated per specification (cf. claim 5). In another embodiment of the invention, the force or torque setpoint values to be generated are predetermined for the slave drive, in particular its current regulator, as a control variable or command variable within the context of a control chain (open) or as the setpoint value within the context of a (closed) control loop (cf. claim 6).

The torque control value or setpoint value is usually applied to the slave drive and thus to the (second) forming means via a corresponding motor current flow. However, there are often mechanical transmission links, in particular gears or the like, between the drive and the forming means, which are installed between the electric drive and the forming means (for example, gear-type shaping wheels). Mechanical friction losses unavoidably occur in this process. As a remedy, according to an optional embodiment of the invention, it is proposed that the force or torque setpoint value should be linked to, precontrolled by or acted upon by an additional force and/or an additional torque, for example, added up, said force or torque setpoint being obtained by weighting or filtering a position value and/or a speed value of the drive master drive or of the first forming means (assigned to it) (referred to as the “master speed value”) with a predefined linear or nonlinear characteristic or function table (cf. claim 7). The profile of the characteristic line or the function table can be determined empirically, for example, on the basis of a measurement series, or approximated theoretically for compensation of the aforementioned friction losses or other losses in the mechanical transmission.

According to another variant of the invention, the slave drive is operated with the force or torque setpoint value as a guide variable in force or torque regulation, wherein the force or torque setpoint value is subject to a comparison with a force or torque actual value, measured on preferably at least one of the forming means (cf. claim 8). This achieves the advantage that loss moments caused by mechanical friction, for example, can be regulated out directly. Pilot control with an additional force and/or an additional torque is no longer absolutely necessary. Use of a PI regulator (proportional/integral regulator) is expedient to rule out the regulating difference; this regulator is subjected to a pilot control with the force or torque setpoint value as the basic setpoint value (cf. claim 9). The PI regulator need then only smooth out minor control deviations. The control dynamics can thus be improved through this pilot control.

According to another variant of the invention, the slave drive is operated in speed control and/or position control at a dynamic limit and/or torque limit that is preselected as a function of or influenced by the master position value and/or force or torque setpoint value (cf. claim 10). In electrical drive technology, it is known that a “torque and current limitation” function block can be assigned mainly to the speed control and/or rpm control, which serves to provide device protection, among other things. The slave drive, which is expediently a servo drive, regularly has a cruise control and/or rpm regulator with an integrating component. If there is constantly a deviation in the rotational speed, the cruise control and/or rpm regulator is driven to its dynamic limit (saturation) by means of its integrating component. This dynamic limit can be influenced and can be preselected. Within the context of the present invention, the variable dynamic limit and/or the adjustable saturation amount is expediently (also) set by means of the torque setpoint value. In a refinement of this idea, the rpm setpoint value and/or position setpoint value for the slave drive is generated as a function of the plus or minus sign or the direction of the force or torque setpoint value, such that the rpm and/or position setpoint value for the slave drive is greater than or less than the rpm and/or position setpoint value for the master drive (cf. claim 11). There is therefore always an rpm deviation beyond which the dynamic limit is reached. As already indicated above, it is within the scope of expedient design according to the invention to use a regulator in the speed drive, in particular a cruise control with an integrating component (I component) in such a way that the regulator is run to its torque limit (cf. claim 12). In the case of forming means that can be operated rotationally in particular, one variant of the invention, in which the master drive and/or the slave drive is/are operated alternately in generator mode or in motor mode, basically so they are complementary to one another, depending on their instantaneous (rotational) position, with the forming means brought into engagement. This is true pending any friction losses. The transition from motor operation to generator operation does not take place obligatorily but instead depends on whether the force resultant on the slave wheel as the forming means, acting against the direction of rotation is greater or smaller than the pressing force required in the process technology. It may thus happen that the slave wheel operates as a motor for a complete cycle because of the friction conditions.

To generate the aforementioned tension between the forming means, they and/or the master drive and slave drive operate more or less “against one another.” What this means for the slave drive, for example, is, firstly, that it operates as a motor drive, i.e., it provides more drives than the master drive. Secondly, after rolling along half a gearing period of rotational forming means with a gear wheel-type shaping profile, the slave drive decelerates the master drive, which results in generator operation for the slave drive. This is true similarly of other types of shaping profiles of other types (not of the gear wheel type) but nevertheless periodic in the case of forming means that can be operated rotationally and/or translationally. From this standpoint, one expedient variant of the invention consists of activating the drives with different and/or opposing or directed torque-position setpoint values and/or speed setpoint values (cf. claim 14), so that the forming means that are in engagement exert forces and/or torques against one another. The aforementioned tension can be achieved, for example, by the fact that one of the drives can always be allowed to run somewhat faster or further in terms of position than the other, which is adjustable by means of oppositely directed setpoint values, with the possible consequence that setpoint values that cannot be achieved are preselected for the slave drive.

According to an embodiment of the invention, as mentioned above, the defined torque is made as a function of the “master position” so the goal is for this master position to be always available in a functional and targeted manner. This is taken into account in one embodiment of the invention such that the drive(s) is/are designed and/or operated so that the master drive always achieves its stipulation with respect to position, speed, force and/or torque despite the tension on the forming means (cf. claim 15). This requires a master drive that is capable of retaining its position or speed even when the slave drive acts with a driving or decelerating force against the master drive.

According to one embodiment of the invention, the economic aspect of the production and storage when the same types of motors with the same power rating are used for both the master drive and the slave drive. Thus, drives of the same maximum power, force and/or torque potential are used, but without limiting and/or exhausting the maximum power, force and/or torque potential of the slave drive in the control technology with respect to or in comparison with those of the master drive (cf. claim 16). On the other hand, it is also within the scope of the invention for the slave-forming means, i.e., the following forming means, to select a smaller (slave) drive if both the master drive and the slave drive are to be utilized 100%. The master drive is expediently operated, so that it can develop its torque 100%. The torque developed by the slave drive must then be smaller in order not to impair the generation of a functionally correct master position value. A corresponding adjustment and/or limitation for the slave drive can be achieved by scaling a characteristic line link/an electronic cam for conversion of the master position value into a force and/or torque setpoint value (see below) for the slave drive. However, full utilization of the slave drive to generate a maximum force and/or its maximum torque can be prevented not only by means of a direct force or a default torque but also by means of a force or torque limitation (see above). In the sense of the embodiment of the invention, this predetermination of the force and/or torque setpoint characteristic either acts on the force or torque limitation or acts directly as a torque setpoint value for the slave drive (omitting a speed control/rpm regulator and position regulator).

A drive configuration suitable for performing the drive method according to the invention in particular, wherein this configuration is equipped with two forming means that are arranged in such a way that they can be brought into a force-fitting and/or form-fitting engagement with one another, is characterized by the following: The forming means can each be controlled and coordinated with its own electric servo drive or some other electric drive; the aforementioned servo drives or electric drive can be controlled and coordinated by a (higher level) control or guiding device; the control device is equipped and designed in terms of the circuitry and/or programming to activate the electric drives to apply tension to the forming means against one another (cf. claim 17). This configuration implies that the forming means are arranged with a predetermined distance between them, depending on the thickness of the material web to be processed, to form opposing contact surfaces and pressing surfaces and/or a passage gap for the material web arranged in between.

According to one variant of the invention, the electric drives are configured as master drives and as slave drives following the former and/or dominated by the former. The control unit therefore comprises a source for making available a master position value, and a linear or nonlinear characteristic line member connected to the source for converting the master position value into a torque setpoint value. The latter can be supplied to control means of the slave drive for processing and implementation (cf. claim 18). The characteristic line member may be stored, for example, in a memory region of the control unit, for example, as a function table in which the respective torque setpoint values are assigned to master position values. In a further embodiment of this variant of the invention, the characteristic line member is designed with a function curve and/or as an allocation table and/or as an electronic cam disk, which corresponds to a shaping profile, optionally with curves or some other geometry or topography of the forming means (cf. claim 19). In this embodiment, in the case of shaping means that resemble gear wheels or are otherwise rotationally symmetrical the resulting periodicity of the shaping profile at the circumference can expediently be imaged in the manner of a cam disk. A change in the pair of forming means can be taken into account by replacing the electronic cam disk and/or the characteristic line member.

For compensation of friction losses, as already mentioned above, it is expedient to have a pilot control for the torque setpoint value accordingly. This is served in particular by the design according to the invention, in which the control unit comprises a summation member upstream from the control means of the slave drive and which is connected to the output of the torque setpoint value characteristic line member and the output of another torque characteristic line member, which serves in particular to compensate for the friction losses between the forming means (cf. claim 20).

In another design according to the invention, the control unit comprises a regulating member and a setpoint/actual value comparator upstream from the input of the control member. The setpoint/actual value comparator is connected at the input end to the torque setpoint characteristic line member and to a torque actual value source. The control member output is sent to the control means of the slave drive (cf. claim 21). The torque actual value can be measured on the forming means connected to the master drive or the slave drive. In this design, measures or means for friction compensation are no longer necessary because any friction losses can be detected and regulated out by taking into account the actual value of the torque. However, the complexity of a torque measurement must be taken into account.

According to another embodiment of the invention, the control unit comprises a direction detector downstream from the torque setpoint value characteristic line member, additionally comprising more or less a plus or minus sign filter and a setpoint value generator for the position and/or speed of the slave drive. The setpoint value generator is connected at the input to the aforementioned master position value source and to the output of the direction detector (plus or minus sign filter) and is adjusted or designed through the program and/or circuitry to generate a speed and/or position setpoint value for the slave drive as a function of the input variables, wherein the slave drive is larger than or smaller than the master drive (cf. claim 22). In this design, it is advantageous that the usual control structure can continue to be used with no change in the preferred design of the slave drive as a servo drive, with the limiting member with the position, rpm and current regulators, optionally with the rpm and current regulators connected in between.

### BRIEF DESCRIPTION OF THE VIEWS OF THE DRAWINGS

Additional details, features, combinations of figures, effects and advantages based on the invention are derived from the following description of preferred exemplary embodiments and the drawings, in which:

FIG. 1 shows an axial view of two shaping wheels as forming means intermeshing in a gear-type manner;

FIG. 2-FIG. 4 show block diagrams of various control and/or regulating structures for controlling the slave drive;

FIGS. 5a-h show axial views of individual shots of the torque curve during one tooth pitch.

### DETAILED DESCRIPTION OF THE INVENTION

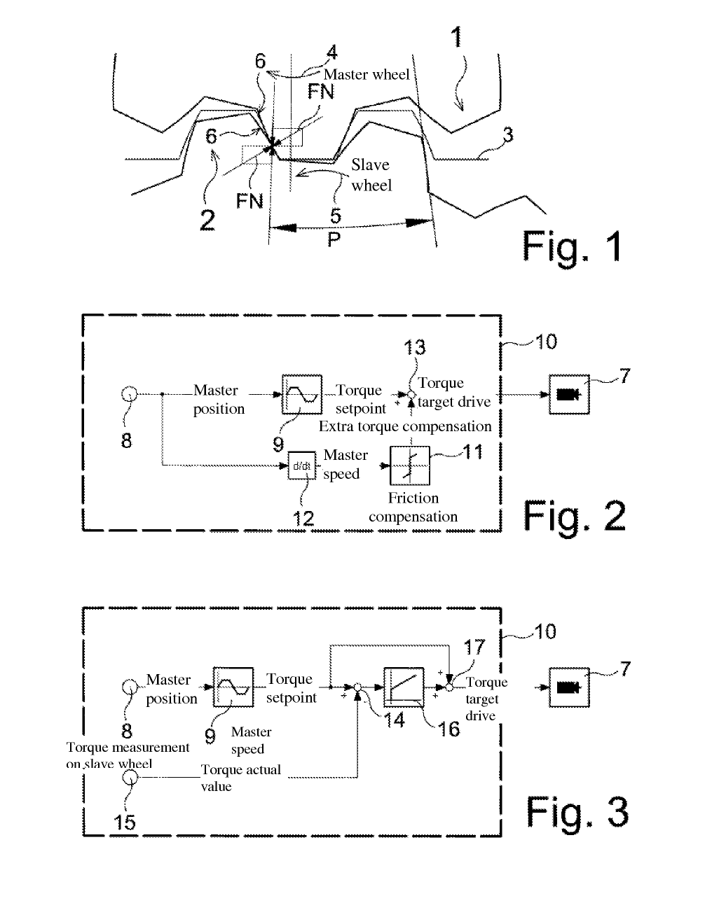

According to FIG. 1, a material web 3 is guided between two forming wheels 1, 2, which are like gear wheels engaging with one another in a force-fitting and form-fitting manner, and is pressed under the influence of temperature and pressure and shaped to form a corrugated profile. For example, a toothed rod profile may be shaped into the material web. To do so a clockwise rotation 4 is imparted to the first forming wheel, i.e., the master wheel 1, by means of a dedicated servo motor, and a counterclockwise rotation 5 is imparted by means of an additional dedicated servo motor to the second forming wheel, i.e., the slave wheel 2, which is subordinate to the master wheel 1. The forming wheels 1, 2 can be driven independently by means of the respective servo motor. This independence of the drives is used by the control and regulation system mentioned above and below to create a constant surface pressure, which is usually desired, for shaping the material and/or material web 3 passing between the forming wheels 1, 2 over the entire corrugated type structure of the material web 3. According to force vectors in FIG. 1, oppositely directed normal forces FN are exerted by the respective tooth flanks 6 of the master wheel 1 and of the slave drive 2 on the material web 3 on both sides, in accordance with force vectors in FIG. 1. These opposing normal forces FN are derived from the fact that the master wheel 1 and the slave wheel 2 operate in the sense of a “tension” with their shaping profiles that resemble gear wheels. The goal is for these normal forces FN and/or the tension and/or the resulting surface pressure (force per unit of area and/or pressure) to be kept constant for the material web 3 over the entire corrugated structure. However, because of the geometry, in particular the geometry of the gearing, there is some flank play with the gearing period P. Thus torques that are so varied that the corrugation and gear wheel geometry are to be taken into account with a flank play for the master wheel 1 and for the slave wheel 2 and in the case of tension on the forming wheels 1, 2 opposite one another a normal force that is usually constant and a surface pressure on the material web 3 are the result. The drive methods mentioned above serve to keep the surface pressure constant over the entire tooth profile with a varying geometry by means of suitably controlled or regulated shaping moments with corresponding tension.

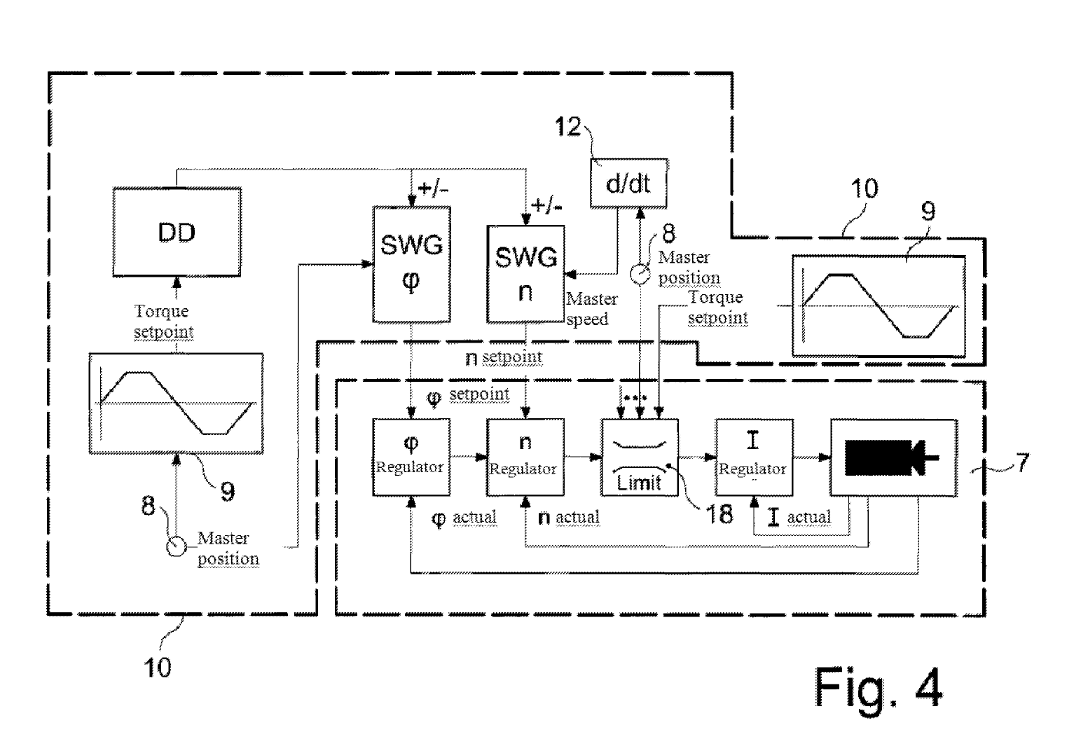

According to the drive method variant illustrated in FIG. 2, the constant surface pressure can be implemented in a controlled operation with presetting of the tension and a defined surface pressure. The drive of the first forming wheel 1 has the function of a leading drive (“master”) and is preferably operated in position control at a constant rotational speed (not shown). As already indicated, the drive 7 of the second forming wheel 2 (following drive, “slave drive”) applies tension to the gearing between the two forming wheels 1, 2 (cf. FIG. 1), so that the oppositely directed normal forces FN and thus the surface pressure on the unrolling tooth flank 6 is created for shaping the material web 3 running in between them. It is expedient here to operate the slave drive 7 by torque control (in the event of a servo drive, it may be operated by a current regulation equivalent thereto). A torque setpoint value is presented for the slave drive 7 as a function of the master position (target position or actual position of the master drive or of the master wheel 1), which is made available by means of a master position value source 8. To generate the torque setpoint value as a function of the master position value for applying tension to the forming wheel, the output of the source 8 is sent to a linear or nonlinear characteristic line member 9 for generating angle-dependent torque setpoint values. The characteristic line member 9 is expediently implemented as a function table and/or as an essentially known electronic cam disk, for which purpose and adaptation to the respective (gear wheel) geometry of forming wheels 1, 2 that are currently in use can be performed by means of software updates or parameter updates. The characteristic line member 9 is expediently stored as a table for the setpoint torque of the drive 7 as a function of the master position value and/or the master position from the source 8.

The resulting torque on the tooth flanks of the forming wheels 1, 2 can be falsified in some cases due to friction (e.g., in a gear between the drive wheel and the forming wheel) in the drive train of the slave wheel 2, especially since the torque of the slave wheel 2 acts in the direction of rotation 5 or opposite that direction depending on its tooth flank, which is currently applying pressure. The driving torque would be reduced by the amount of the friction losses and the decelerating torque would be increased accordingly. Therefore according to FIG. 2 an rpm-dependent friction loss curve is stored in the drive control and/or drive control unit 10 in another characteristic line member 11. The friction compensation characteristic line member 11 is connected at the input end to a differentiating member 12, whose input is supplied by the master position values source 8. The output of the friction compensation characteristic line member 11 is sent to an adding member 13, the second input of which is connected to the output of the torque setpoint value characteristic line member 9. An addition of a specific friction compensation torque to the defined torque from the moment setpoint characteristic line member 9 and/or from the “pressure curve” for the slave drive 7 results from this arrangement of the function components. The output of the adding member 13 then forms the actual defined torque for the slave drive 7, for example, the setpoint value for the current regulator of a servo drive. If the friction losses change during operation (for example, due to changes in temperature in the gear, wear or abrasion on the gear), this can be taken into account in the exemplary embodiment according to FIG. 2 only by adaptation and/or an update of the characteristic line member and/or the electronic cam disk. Otherwise there would be a deviation from the desired setpoint pressure on the material web 3.

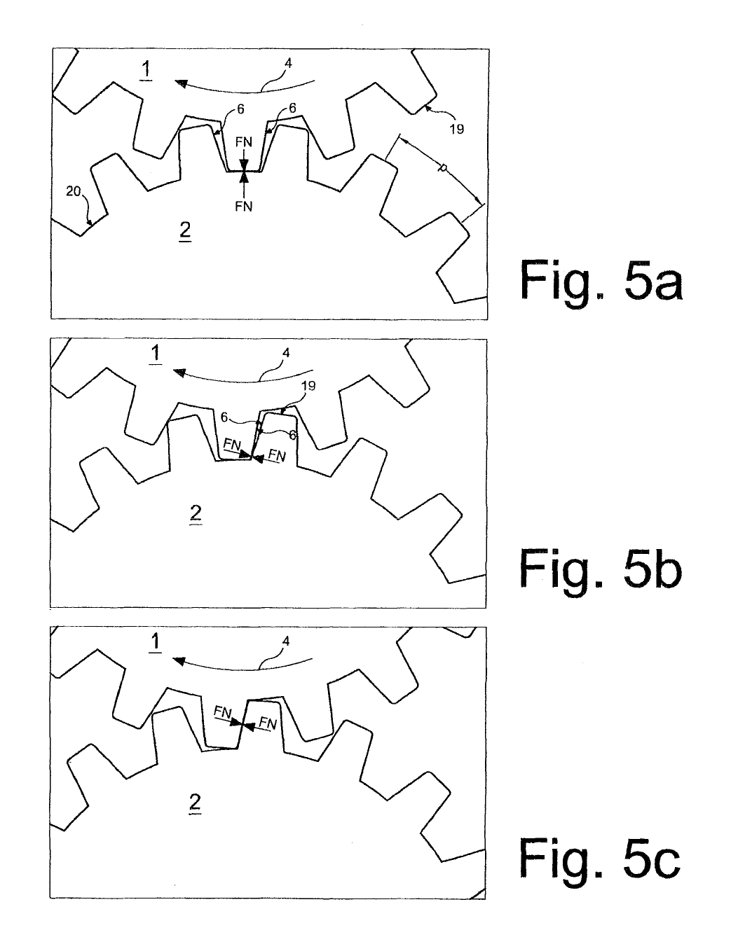

As an expedient and to increase the function accuracy, a torque actual value feedback is implemented in the exemplary embodiment according to FIG. 3. The basic setpoint value is generated with the master position value source 8 and the downstream torque setpoint value characteristic line member 9 by analogy with the exemplary embodiment according to FIG. 2. Furthermore, the actual torque is measured directly on the master wheel 1 or the slave wheel 2. This can be implemented, for example, by means of a torque measuring shaft or by means of force measurement in a torque support on the gear dispensing end. In a setpoint/actual value comparator 14, which is connected at its (negative) feedback input to a torque actual value source 15, a regulating difference, which is regulated out by means of a proportional integral regulator (PI regulator) 16, is generated. The output of the proportional integral regulator is sent to a pilot control summation member 17, whose second positive input is connected to the output of the torque setpoint characteristic line member 9. The demand for adjusting torque for the slave drive 7 can be taken into account with this pilot control of the PI regulator 16, as expected on the basis of the profile of the torque setpoint value from the corresponding characteristic line member 9. The current status of the friction losses can be taken into account via the feedback loop with the actual value of the torque from the corresponding source 15 and a falsification or faulty influence due to changes in the boundary conditions over time (aging, changes in temperature of the gear, etc.) can be prevented. The torque measurement can be implemented by using essentially known standard measurement equipment.

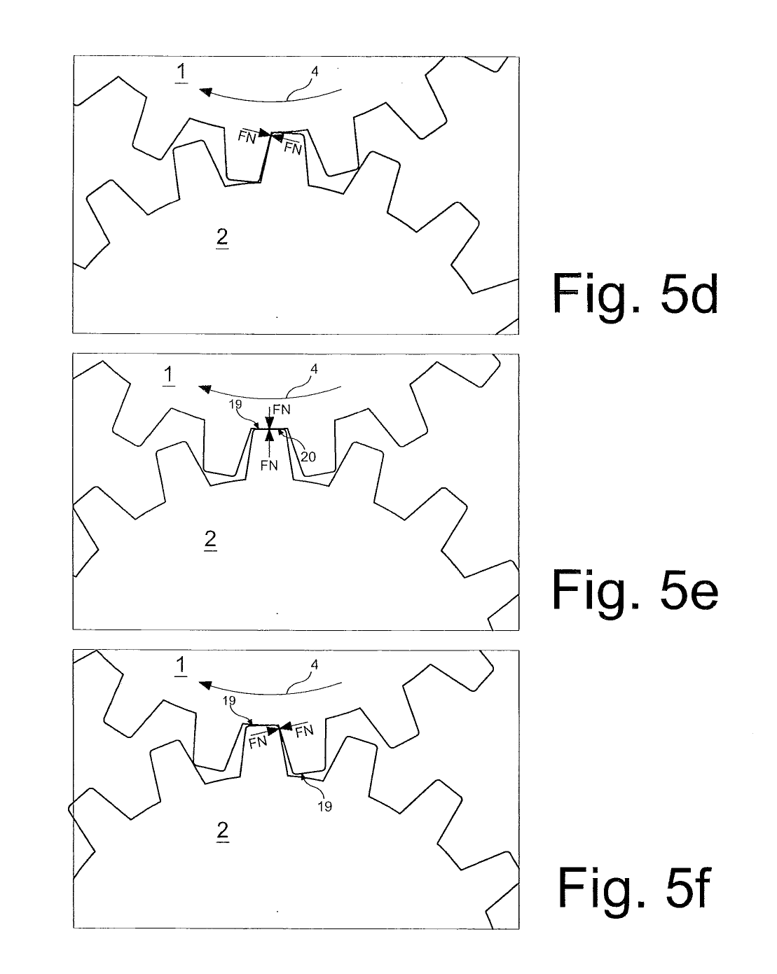

According to FIG. 4, the slave drive 7 is operated with position and torque control in accordance with the regulation structure that is customary with a servo drive. Setpoint values for the angle position Φₛₑₜ and the torque nₛₑₜ are generated by respective setpoint generators SWGφ, SWGn and sent to the respective regulators φ_{regulator}, n_{regulator}. The basic setpoint value for the torque is generated from the master position value source 8 via the torque setpoint characteristic line member 9 by analogy with the exemplary embodiments according to FIG. 2 and FIG. 3. By means of a direction detector DD, which is connected at the input to the output of the torque setpoint characteristic line member 9 within the control unit 10, the plus or minus sign and/or the direction of the torque setpoint value is/are ascertained and sent to the respective input of the setpoint generator SWGφ, SWGn. The setpoint generators are equipped and designed in terms of circuitry and/or software, so that they generate setpoint values for the angle position regulators and rpm regulator of the slave drive 7, which are greater than and smaller than, respectively, the angle position value and the rpm value of the master drive (not shown) on the basis of the direction of the torque setpoint value and as a function of the master position value and/or the master position. The rpm regulator n_{regulator} is operated to its dynamic limit, i.e., saturation, by means of its available I component, and/or the slave drive is unavoidably forced to its corresponding torque limit (motor or generator). Thus a position setpoint value or an rpm setpoint value is preselected for the rpm regulator n_{regulator} but it cannot be achieved because of the geometry of the forming means 1, 2, so that the rpm regulator n_{regulator} is run to its dynamic limit, i.e., saturation. However, this slave drive 7 has a function lock 18 and/or a functionality inherent in the rpm regulator n_{regulator} for limiting the torque and/or current. In the present exemplary embodiment, the amount of the saturation of the rpm regulator can be adjusted according to the torque setpoint value from the corresponding characteristic line member 9. The dynamic limit of the rpm regulator is variable and is thus also adjustable as a function of the torques setpoint value. Alternatively or additionally, the amount of the torque limit can also be preselected as a function of the master position and/or of the output of the master position value source 8. To do so, it is expedient to design the master drive and the slave drive so that the master drive always achieves its defined position and/or defined torque regardless of the tension on the forming wheels/rollers 1, 2.

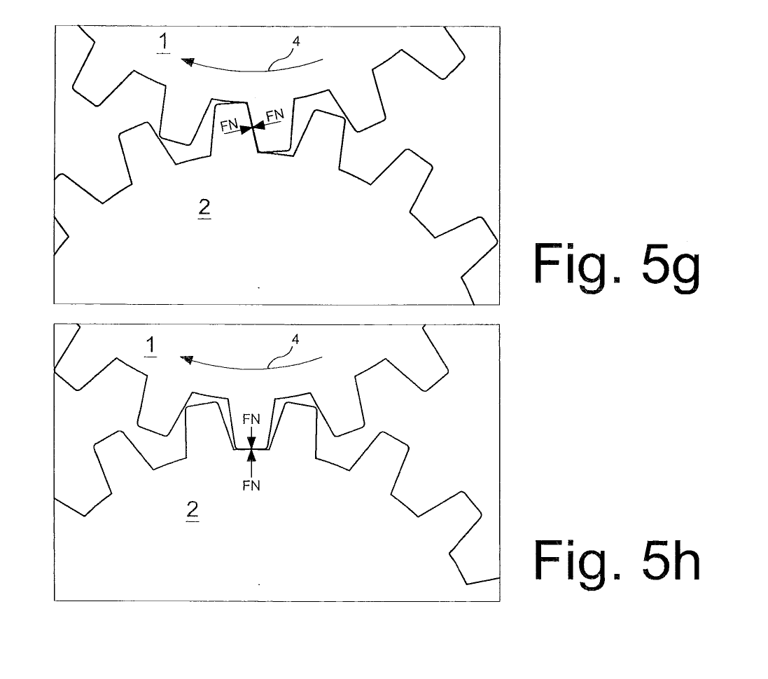

The following explanation is given for the mechanism of action of the present invention on the basis of the torque curve during one tooth pitch p according to FIG. 5a-FIG. 5h.

According to FIG. 5a, the master wheel 1 and the slave wheel 2 are mutually engaged and are in a zero degree position with respect to their angle settings/rotational positions. In this position, the opposing normal forces FN, which emanate from the master wheel 1 and the slave wheel 2, are directed radially with respect to their wheel axes, and the tooth head 19 of a master wheel tooth that has just become active is opposite a tooth gap base 20 of the slave wheel 2 frontally with a minimum distance. A surface pressure of a valley of the wave-shaped profile or toothed rod profile of the material web 3 may occur here. In the 0° position according to FIG. 5a, there is no surface pressure in the region of the tooth flanks 6 and no torques are necessary for generating this surface pressure and/or the tension between the master wheel 1 and the slave wheel 2. However, a surface pressure of the material web 3 may also occur between the tooth head 19 and the tooth gap base 20. Furthermore, there is a shaping and/or curvature of the material web profile in the corner regions or the transitional regions of “valley/hill” of the gearing to form the corrugated shape. Furthermore, in the 0° position, there is a change from a previous generator operation of the slave drive 7 (with generator torque direction on the slave wheel 2) to motor operation of the slave drive 7 (with motor torque direction on the slave wheel 2).

According to FIGS. 5b-5d, the torque on the slave wheel 2 is aligned with the motor, i.e., it drives against the master wheel 1 so as to result in opposing normal forces FN acting on the opposing tooth flanks 6 with the resulting tension of the forming wheels 1, 2. With increasing rolling according to FIGS. 5b-5d, the radius of attack of the normal forces FN is lengthened with respect to the middle axis or axis of rotation of the slave wheel 2, i.e., the point of attack of the normal forces FN travel upward from the tooth gap base 20 of the slave wheel 2 to the tooth head 19 of the slave wheel tooth, which drives against the opposing rear flank of the tooth of the master wheel 1, which is currently active, does this with its front flank, which is active in the direction of rotation according to the motor operation against the opposing rear flank of the tooth of the master wheel 1 that is currently active. This tension effect is achieved by the fact that the slave wheel 2 more or less attempts to rotate somewhat faster than the master wheel 1.

According to FIG. 5e, the master and slave wheel 1, 2 have now reached the 180° rotational position, i.e., have run through half of the tooth pitch p. The tooth head 19 of the slave wheel tooth that was previously the driving tooth is opposite the corresponding tooth gap base 20 of the master wheel frontally with a minimum distance, and the normal forces FN emanating from the two forming wheels 1, 2 are directly radially with respect to the axes of rotation of the wheel. In order for the tooth flank change not to take place jerkily but instead to be as smooth and harmonious as possible, the position control of the slave drive 7, which was mentioned above is particularly advantageous at its torque limit. According to FIG. 5e, there is now a change from a motor moment direction to a generator moment direction on the slave wheel 2 in the 180° position of rotation. Then the rear flank in the direction of rotation becomes active for the surface pressure on the tooth of the slave wheel 2, which has just become active, and the front flank of the opposing tooth of the master wheel 1 in the direction of rotation begins to build up a pressing force.

FIGS. 5e through 5h illustrate how the surface pressure and/or tension is applied. Oppositely directed normal forces FN occur on the opposing tooth flanks of the master wheel 1 and the slave wheel 2, such that the material web 3 can be pressed between them. As in FIGS. 5b-5d, the point of attack of the opposite normal forces FN travels from the tooth gap base 20 of the master wheel 1 to its tooth head 19.

It is advantageous if the tooth flanks 6 are provided with convex curvatures so that the contact surface and the required pressing force and/or tension can be minimized. There is therefore a dynamic range, which is not too large for the torque setpoint value stipulation and/or the torque limit. Actual saturation limits can be taken into account.

Because of the additional method of manufacturing the corrugated material web 3 and honeycomb structures, reference is made to the older patent application PCT/EP2012/062241 by the same applicant, which was published subsequently.

### LIST OF REFERENCE NUMERALS

1 first forming wheel (master wheel)
2 second forming wheel (slave wheel)
3 material web
4, 5 directions of rotation
6 tooth flank
FN normal force
P gearing period
7 slave drive
8 source for master position value
9 torque setpoint value characteristic line member
10 control unit for drive
11 friction compensation characteristic line member
12 differentiating member
13 adding member
14 setpoint/actual value comparator
15 torque actual value source
16 PI regulator
17 pilot control summation member
SWGφ setpoint generator for angle position φ
SWGn setpoint generator for rpm n
φₛₑₜ angle position setpoint value
nₛₑₜ rotational speed setpoint value
DD direction detector
18 function for current limitation
19 tooth head
20 tooth gap base

1. A drive method for movement of a first and a second forming means (1, 2) for processing of a material web arranged between these forming means, wherein the forming means (1, 2) and the material web (3) are brought into a force-fitting or form-fitting engagement between the forming means, characterized in that a dedicated drive is assigned to each of the forming means (1, 2) and the drives are activated to cause the forming means (1, 2) to exert a predefined pressing force against one another and thereby also onto the material web (3).

2. The drive method according to claim 1, characterized in that the drives are activated in such a way that the forming means (1, 2) are stressed against one another, with the material web (3) in between, to produce the pressing force.

3. The drive method according to claim 2, characterized in that a first drive, as a master drive, connected to the first forming means (1) and a second drive (7), as a slave drive, connected to the second forming means (2) are used, and the slave drive (7) is activated or operated as a function of or under the influence of a master position value of the master drive or of the first forming means (1).

4. The drive method according to claim 3, characterized in that one force setpoint value or one torque setpoint value is assigned to each master position values, wherein the slave drive (7) is activated or operated as a function of or influenced by the same.

5. The drive method according to claim 4, characterized in that the master position values and the force or torque setpoint values are assigned according to a shaping profile or to some other geometry or topography of the forming means (1, 2) or according to the pressing force to be generated.

6. The drive method according to claim 5, characterized in that the force or torque setpoint value is preselected for a slave drive (7) current regulator (I_{regulator}) as a control value or guide value within the context of a control chain or as a setpoint value within the context of a regulating circuit.

7. The drive method according to claim 6, characterized in that the force or torque setpoint value is linked to an additional force or additional torque value, this value being obtained by weighting of a position or rotational speed value of the master drive or first forming means (1) with a characteristic line (11) predetermined for compensation of friction losses or other losses.

8. The drive method according to claim 7, characterized in that the slave drive (7) is operated in force or torque regulation with the force or torque setpoint value as a guide variable, wherein the force or torque setpoint value is subjected to a comparison (14) with a force or torque actual value (15) measured on at least one of the forming means (1, 2).

9. The drive method according to claim 8, characterized in that a regulating difference resulting from the comparison is regulated out using a PI regulator (16) which is subjected to a pilot control (17) with the force or torque setpoint value.

10. The drive method according to claim 4, characterized in that the slave drive (7) is operated in rpm or position regulation at a dynamic limit or a torque limit which is preselected as a function of or influenced by the master position value (8) or the force or torque setpoint value.

11. The drive method according to claim 10, characterized in that an rpm or position setpoint value for the slave drive (7) is generated as a function of a plus or minus sign or a direction of the force or torque setpoint value, such that the rpm or position setpoint value (nₛₑₜₚₒᵢₙₜ, φₛₑₜₚₒᵢₙₜ) for the slave drive (7) is greater or smaller than the rotational speed setpoint value or a position setpoint value for the master drive.

12. The drive method according to claim 11, characterized in that a cruise control (n_{regulator}) regulator having an integrating component is used with the slave drive (7) and guides the regulator into its torque limit.

13. The drive method according to claim 12, characterized in that, with the forming means (1, 2) brought into engagement, the master drive or slave drive (7) is operated in generator mode and in motor mode alternately, depending on its position, such that they are complementary to one another.

14. The drive method according to claim 13, characterized by an activation of the drives with different or opposing torques, positions or speed setpoint values.

15. The drive method according to claim 2, characterized in that the drives operated so that the master drive always achieves any of its defined position, speed, or force despite the tension on the forming means (1, 2).

16. The drive method according to claim 2, characterized by the use of drives of the same maximum power, force or torque potential wherein maximum power, force or maximum torque potential of the slave drive (7) with respect to that of the master drive is limited or not fully exhausted in terms of control technology with respect to that of the master drive.

17. A drive arrangement having two forming means (1, 2) that can be brought into a force-fitting or form-fitting engagement with one another and are arranged such that a material web (3) to be processed can find room between them, characterized in that the forming means (1, 2) are each connected to a dedicated electric servo drive (7) or some other electric drive, which can be controlled and coordinated by a control unit (10) and a control unit (10) is equipped and designed in terms of the circuitry or software to activate the electric drives for applying tension forces to the forming means (1, 2) toward one another.

18. The drive arrangement according to claim 17, characterized in that the electric drives are configured as a master drive and a slave drive guided by the master drive, for which the control unit comprises a source (8) for a master position value and a linear or nonlinear characteristic line member (9) connected thereto for converting the master position value into a torque setpoint value which is supplied to a control means of the slave drive (7) to be processed and implemented.

19. The drive arrangement according to claim 18, characterized in that the characteristic line member (9) is designed with a function curve or an assignment table or as an electronic cam disk, which corresponds to a shaping profile or some other geometry or topography of the forming means (1, 2).

20. The drive arrangement according to claim 19, characterized in that the control unit (10) includes a summation member (13) which is upstream from the control means and is connected to the output of the torque setpoint value characteristic line member (9) and to the output of another torque characteristic line member (11) which serves to compensate for friction loses between the forming means (1, 2).

21. The drive arrangement according to claim 20, characterized in that the control unit (10) comprises a regulating member (16) and a setpoint/actual value comparator (14) upstream from the input thereof, connected at the input end to the torque setpoint value characteristic line member (9) and a torque actual value source (15) and the regulating member output is connected to the control means of the slave drive (7).

22. The drive arrangement according to claim 21, characterized in that the control unit (10) comprises a direction detector (DD) downstream from the torque setpoint value characteristic line member (9) and a setpoint value generator (SWG) for the position or speed of the slave drive (7), which is connected at the input to the master position value source (8) and the direction detector output and is designed or adjusted to generate a speed or position setpoint value for the slave drive (7) which is larger or smaller than that of the master drive.
